(19) United States
(12) Patent Application Publication
(10) Pub. No.: US 2011/0173131 A1
(43) Pub. Date: Jul. 14, 2011

(54) Attribute aggregation for standard product unit

(75) Inventors: Feng Huang, Hangzhou (CN); Jianming Zhou, Hangzhou (CN); Guohua Liu, Hangzhou (CN); Bohan Kong, Hangzhou (CN)

(73) Assignee: Alibaba Group Holding Limited

(21) Appl. No.: 12/930,613

(22) Filed: Jan. 11, 2011

(30) Foreign Application Priority Data
Jan. 13, 2010 (CN) 201010000544.X

(51) Int. Cl. G06Q 30/00

(52) U.S. Cl. 705/347

(57) ABSTRACT

Attribute aggregation for a standard product unit (SPU) includes: receiving an attribute and a corresponding attribute value for a product; storing the attribute and the corresponding attribute value for the product; determining a frequency of the attribute and a frequency of the corresponding attribute value; aggregating the attribute and the corresponding attribute value based at least in part on the frequency of the attribute and the frequency of the corresponding attribute value according to a predetermined attribute aggregation rule; and generating a standard product unit of attribute information for the product.

### CROSS REFERENCE TO OTHER APPLICATIONS

This application claims priority to People's Republic of China Patent Application No. 201010000544.X entitled METHOD, DEVICE AND SYSTEM OF ATTRIBUTE AGGREGATION FOR STANDARD PRODUCT UNIT filed Jan. 13, 2010 which is incorporated herein by reference for all purposes.

### FIELD OF THE INVENTION

The present invention relates generally to the field of computer systems and, more particularly, to a method and a system of aggregating product information.

### BACKGROUND OF THE INVENTION

At an electronic commerce website, there is an abundance of transaction information, including attribute information of the products that are on sale. The attribute information of a product may be input (i.e., entered into a user interface associated with the electronic commerce website) by sellers when sellers advertise their products for sale on the electronic commerce website. Typically, when sellers advertise a product on an electronic commerce website, they input corresponding attribute information. Corresponding attribute information may include attribute pairs, where each pair includes an attribute and a corresponding attribute value. Although attributes and attributes values are limited, sellers do not always input the correct or intended attribute values when they advertise their products, which causes inaccurate attribute information to be available at the websites.

Typically, revising inaccurate attribute information is performed manually. However, due to the limitation of human cognition and memory, it is very difficult to achieve complete accuracy with manual revision. Moreover, in some cases, manual revision requires a client of the background management system to send frequent revision instructions to the website server, which reduces the communication speed between client and website server. Also, frequently sending revision instructions increases the work load of the server.

### BRIEF DESCRIPTION OF THE DRAWINGS

Various embodiments of the invention are disclosed in the following detailed description and the accompanying drawings.

FIG. 1 is a flow diagram of an embodiment of aggregating attribute information for a SPU;

FIG. 2 is a diagram of an embodiment of a system for aggregating attribute information for a SPU;

FIG. 3 is a flow diagram showing an embodiment of a process of keeping track of trading information;

FIG. 4 is a flow diagram showing an embodiment of aggregating attributes for generating SPUs;

FIG. 5 is an example of attribute aggregation for creating SPU attribute information;

FIG. 6 is a diagram showing an embodiment of a system for attribute aggregation for generating SPU;

FIG. 7 is a diagram of an embodiment of a system for attribute aggregation for generating SPU;

FIG. 8 is a diagram of an embodiment of a system for attribute aggregation for generating SPU.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A standard product unit (SPU) is a set of standardized information which is reusable and easy to search. This set of information describes features (e.g., attribute pairs) of a product. In some embodiments, a SPU contains reference information for one or more products. A SPU refers to the smallest unit of aggregation of distinct product information for a set of products. In various embodiments, a SPU may be used to describe a group of similar products (e.g., products with similar features). In the process of creating, organizing, or managing merchandise information (e.g., for an interne website), a product's features can be described by multiple attribute pairs, and products with identical attribute pairs can be abstracted as being included in the same SPU. Attribute pairs in a SPU may become standardized over time. Product information structure that is comprised of SPUs can be applied in various ways, such as integrated with web information, comments, and other SPUs.

Currently, a SPU is first generated for a product when sellers advertise the product on a website for the first time. A SPU is usually confirmed by several key attributes (some of which required attributes and some are non-required) of the product. However, the attributes in a SPU may be wrong or missing since sellers may input the wrong information of a product (e.g., by accident or based on inaccurate knowledge of the product). At an electronic website, there may be numerous SPUs. Products on the electronic websites are better managed when the SPU information is accurate and complete.

In various embodiments, a reference (i.e., correct) value (or reference values) for an attribute is determined by aggregating a large number of attribute pairs (i.e., inputted information regarding the attribute and various corresponding attribute values) of a product, keeping track of the aggregated attribute pairs of the product and identifying the attribute value(s) that reaches a predetermined requirement as the reference value(s) of the attribute.

In some embodiments, SPUs may contain reference attribute information. SPUs may be used to help users (e.g., potential buyers) at the website to more conveniently search for products. Because SPUs include standardized attributes with accurate attribute values for the corresponding products, a user may search the website for an attribute that is part of a product's SPU and become quickly linked to that product. SPUs also may be used as the information that is displayed at the webpage advertising the corresponding product for sale.

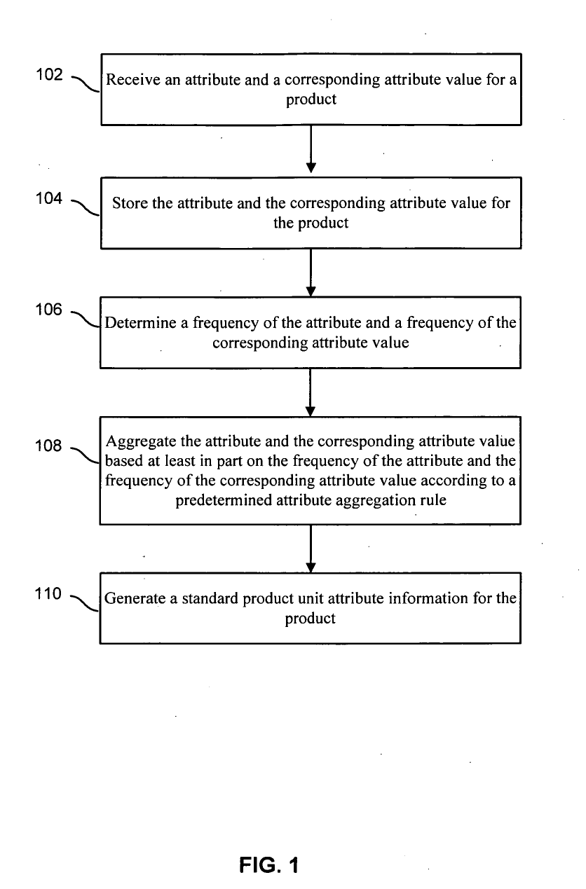

FIG. 1 is a flow diagram of an embodiment of aggregating attribute information for a SPU. The example shown in FIG. 1 includes:

At step 102, an attribute and a corresponding attribute value for a product is received. In some embodiments, the attribute and the corresponding attribute value for the product are input by a seller of the product who wishes to advertise the product at an interne website.

At step 104, the attribute and the corresponding attribute value for the product is stored. In some embodiments, the attribute information is stored so that calculations may be performed with respect to it.

At step 106, a frequency of the attribute and a frequency of the corresponding attribute value are determined. In some embodiments, the frequencies are determined based on the stored attribute information. In some embodiments, a frequency is the ratio or a percentage of the number of times that a certain attribute (or attribute value) is received over the total number of times that any attribute (or any attribute value) has been received.

At step 108, the attribute and the corresponding attribute value are aggregated based at least in part on the frequency of the attribute and the frequency of the corresponding attribute value according to a predetermined attribute aggregation rule. In some embodiments, the predetermined attribute aggregation rule first determines whether the received attribute is a required or a non-required attribute.

At step 110, a standard product unit attribute information for the product is generated. In some embodiments, depending whether the received attribute is a required or non-required attribute, the attribute and the corresponding attribute value are determined to be part of the SPU for the product. In some embodiments, a SPU is generated by storing a set of attribute information with metadata that associates the set of attribute information as the SPU information for one or more products.

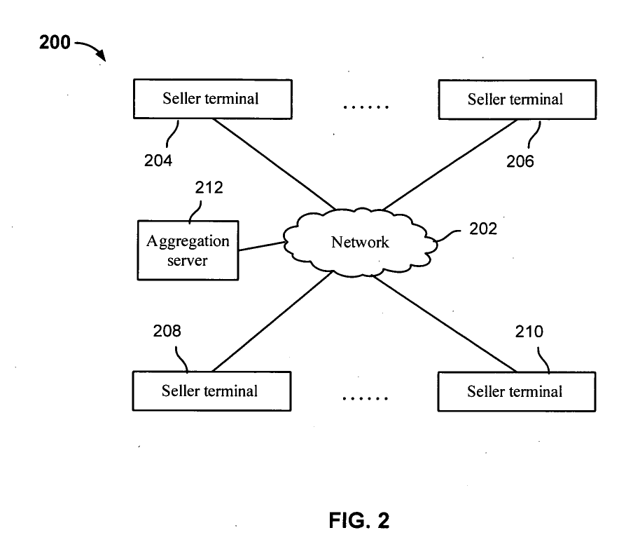

FIG. 2 is a diagram of an embodiment of a system for aggregating attribute information for a SPU. In the example shown, system 200 includes aggregation server 212, network 202, and seller terminals 204, 206, 208, and 210. Aggregation server 212 communicates with seller terminals 204, 206, 208, and 210 through network 202. Network 202 includes various high speed data networks and/or telecommunications networks.

Aggregation server 212 supports a trading platform over which sellers can advertise and sell their products. In various embodiments, the trading platform is an electronic commerce website. In various embodiments, the trading platform may be presented to users (e.g., sellers) who wish to advertise and sell products on the trading platform as an interactive user interface (e.g., the interactive user interface may be utilized through seller terminals such as seller terminals 204, 206, 208, and 210), in which the users can input attribute information regarding the products they wish to sell. In some embodiments, the input attribute information is input as alphanumeric identifiers of attributes and corresponding attribute values. In various embodiments, the attribute information that is input by the sellers is stored on the aggregation server that supports the trading platform. In some embodiments, the trading platform may present information regarding products on sale to buyers using an interactive user interface (e.g., on a webpage of an electronic commerce website) through which buyers may purchase the products.

In some embodiments, a trading platform (supported by aggregation server 212) receives and stores the attribute information of the product that is input by seller. In some embodiments, the trading platform shows SPU attribute information in an attribute display webpage (e.g., at the electronic commerce website) when users (e.g., of the website) search for the corresponding product by a product attribute.

In various embodiments, an attribute information statistics functional module is set up as a component of aggregation server 202. In some embodiments, the attribute information statistics functional module is a component of the trading platform. In various embodiments, the attribute information statistics functional module keeps track of the trading information input by sellers to produce SPUs. Examples of trading information may include product category, product name, product price, product manufacturer, product color, shipping cost of the product, etc., including any required attribute information (e.g., product price), non-required attribute information, single-choice attribute information, multiple-choice attribute information, etc.

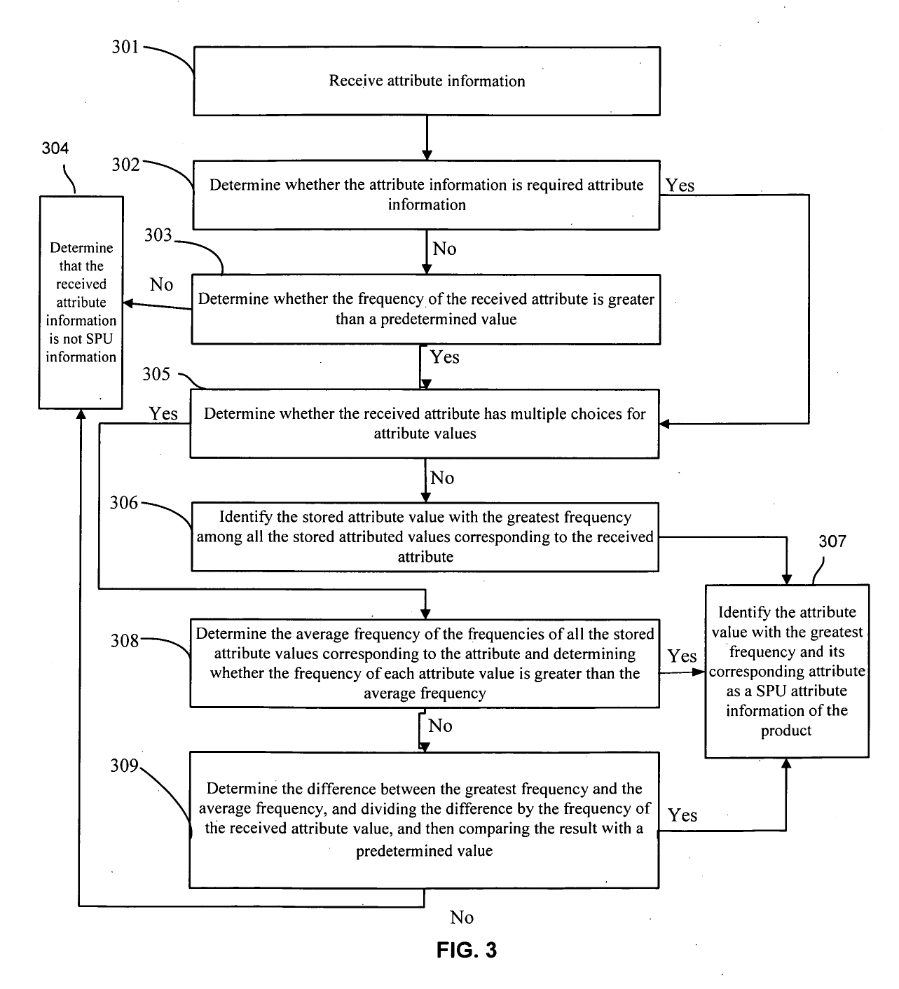

FIG. 3 is a flow diagram showing an embodiment of a process of keeping track of trading information. In various embodiments, process 300 is performed by an attribute information statistics functional module. As shown in the example, process 300 includes the following steps:

At step 301, attribute information is received. The attribute information includes at least an attribute and a corresponding attribute value (i.e., an attribute pair) for a product. In various embodiments, the attribute information is input via a user interface (e.g., presented by an aggregation server) of an electronic commerce website by sellers of products. The attribute information may be received by the aggregation server and processed by the attribute information statistics functional module of the trading platform. The attribute information may also be stored by the aggregation server in association with the trading platform.

In various embodiments, the user interface of the trading platform may contain a section for configuring the attribute information statistics. A seller may input product attribute information using this section of the user interface. In some embodiments, a storage functional module also can be set up on the trading platform to store product attribute information input by the sellers. The storage of product attribute information can be set up in any way that is desirable. For example, a corresponding storage region can be reserved for each SPU to store attribute information of the SPU. In various embodiments, attribute information statistics functional module can also be set up as a component of the trading platform. The attribute information statistics functional module may perform one or more of the following: retrieve attribute information from the storage functional module, perform statistical calculations, obtain SPU attribute information of the product according to a predetermined statistics rule, and revise previously stored SPU attribute information of the product.

In various embodiments, the attribute information statistics functional module keeps track of the number of times that each attribute is received and the number of times that each corresponding attribute value is received. As a consequence, the frequency of each attribute and each corresponding value to the attribute may be calculated:

For example, a product may be a laptop. The received attribution information may include attribute value of “Dell” for the attribute of “manufacturer.” The aggregation server may keep track of other attribute pairs that were previously received. Previously received attribute pairs may include and attribute of “maker” and an attribute value of “Delle”, and attribute of “producer” and an attribute value of “Delll.” The frequencies that the attributes “maker,” “producer,” and “manufacturer” are received may be 30%, 10%, and 70%, respectively. The frequencies that the corresponding attribute values “Delle,” “Delll” and “Dell” are received may be 3%, 40%, and 67%, respectively.

At step 302, it is determined whether the received attribute is a required attribute. If the attribute is not a required attribute, then step 303 is performed, otherwise step 305 is performed.

In various embodiments, a required attribute must be displayed as an attribute of the product (e.g., at a webpage at the electronic commerce website advertising the product for sale) and so its value must be obtained (e.g., as an input from a seller). In some embodiments, an attribute is deemed as a required attribute if it is found on a predetermined list configured by the website operator. In various embodiments, a non-required attribute is an attribute that need not be displayed as an attribute of the product, so the corresponding attribute value is not required (e.g., as an input from a seller). For example, a product of a mobile phone's required attributes include manufacturer, type, color, etc. However, a mobile phone can support the Bluetooth function, but it also need not support the Bluetooth function. Therefore, the Bluetooth attribute of the mobile phone product is a non-required attribute.

At step 303, it is determined whether the frequency of the received attribute is greater than a predetermined value. If the frequency that the received attribute has been received (e.g., at the aggregation server) is not greater than a predetermined value, then step 304 is performed, otherwise step 305 is performed.

In some embodiments, the predetermined value is a threshold frequency. If the frequency of the received attribute is less than the predetermined value or threshold frequency, then it is determined that the attribute does not belong in the set of information to be included in the SPU that includes that product. However, if the frequency of the received attribute exceeds the predetermined value or threshold frequency, then it is determined that the attribute does belong in the set of information to be included in the SPU for that product.

At step 304, it is determined that the received attribute information is not SPU information.

At step 305, it is determined whether the attribute has multiple choices for attribute values. If it does not have multiple choices, then step 306 is performed, otherwise step 308 is performed.

In some embodiments, some attribute information input by sellers may have multiple choices of correct attribute values. For example, the attribute values of the attribute color could be black, white, pink, etc. (e.g., because the corresponding product is in fact manufactured in one of colors black, white, or pink), as opposed to an attribute with multiple choices for values, some other attributes have only a single choice of a correct attribute value (e.g., because the corresponding product either has or does not have a certain function). For example, the attribute value for the attribute of a mobile device having a camera function may only be yes and if the “yes” attribute value is not selected then it is presumed that the mobile device does not have a camera function.

At step 306, the stored attribute value with the greatest frequency among all the stored attribute values corresponding to the received attribute is identified.

At step 307, the attribute value with the greatest frequency and its corresponding attribute are identified as SPU attribute information for the product.

At step 308, the average frequency of the frequencies of all the stored attribute values corresponding to the attribute is determined, and it is determined whether the frequency of each attribute value is greater than the average frequency. If a frequency of an attribute value is greater than the average frequency, then step 307 is performed, otherwise step 309 is performed.

At step 309, the difference between the greatest frequency and the average frequency is determined, and the difference is divided by the frequency of the received attribute value, and then the result is compared with a predetermined value. If the result is less than the predetermined value, then step 307 is performed, otherwise step 304 is performed.

In some embodiments, the preferred predetermined value is 1.3; other values can be used in other embodiments.

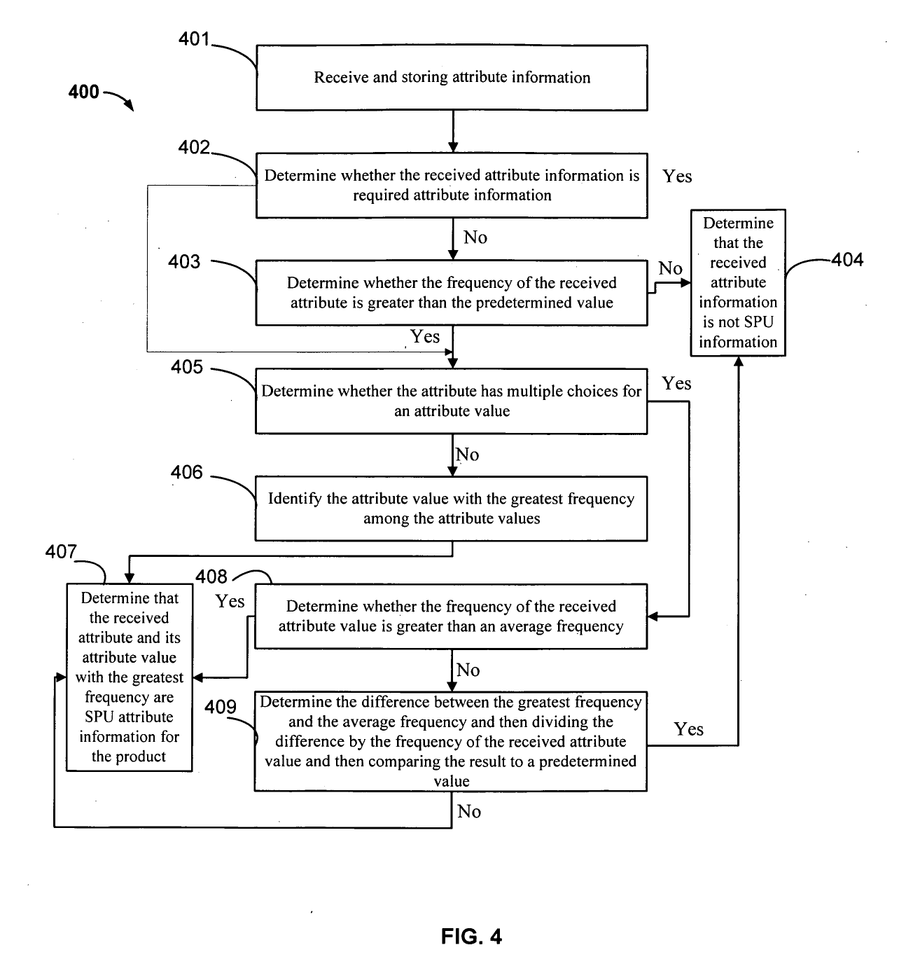

FIG. 4 is a flow diagram showing an embodiment of aggregating attributes for generating SPUs. As shown in the example, process 400 includes the following steps:

At step 401, attribute information is received and stored. In various embodiments, the received attribute information includes an attribute and a corresponding attribute value for a product.

In some embodiments, a trading platform provides a webpage at the user interface for sellers to input various attribute information of the product, including required attributes and non-required attributes. All the attribute information of the product input by sellers is stored at the trading platform (e.g., which is supported by an aggregation server), so that it is convenient to do various calculations to the stored attribute information. The storage of the received attribute information may be organized in various ways. For example, a special server or storage medium may be set up to store attribute information input by sellers. In some embodiments, attribute information can be stored according to predetermined storing rule. For example, the attribute information of each SPU is stored at a specific storage region reserved for that SPU.

At step 402, it is determined whether the received attribute information is required attribute information. If it is not required attribute information, then step 403 is performed, otherwise step 405 is performed.

At step 403, it is determined whether the frequency of the received attribute is greater than the predetermined value. If not, then step 404 is performed, otherwise step 405 is performed.

In some embodiments, a non-required attribute is not an attribute of a product that will be stored if its frequency is too low (e.g., below a certain threshold). Take the non-required Bluetooth Function attribute of the mobile phone product for example. If there is only a few (e.g., 1% or less) sellers who have inputted attribute information regarding Bluetooth support (e.g., the attribute is Bluetooth and the attribute value is whether there is or there is not support of Bluetooth), then it is determined that the mobile phone product does not include a Bluetooth function. In other words, the non-required attribute information of supporting Bluetooth is not determined as a SPU attribute of the mobile phone or even stored as attribute information if too few sellers even input that type of attribute information. In some embodiments, it is determined whether the non-required attribute is attribute information to be stored based on the frequency that the attribute is received. If the frequency that the attribute is received is greater than a predetermined value, it is assumed that the input of the attribute was a regular operation (as opposed to being input on accident) and should be stored. However, if the frequency that the attribute is received is below the predetermined value, then it is assumed that the input of the attribute is not statistically meaningful enough to be stored.

At step 404, it is determined that the received attribute is not a SPU attribute.

In some embodiments, if the frequency of the attribute is not greater than a predetermined value, it is assumed that the attribute information is input by chance or on accident, and so the attribute is not going to be displayed on the sale webpage of the product. In some embodiments, non-required attributes whose frequencies are below the predetermined value are received but not stored.

At step 405, it is determined whether the attribute has multiple choices for an attribute value. If the attribute value is not one of multiple possible attribute values, then step 406 is performed, otherwise step 408 is performed.

In some embodiments, an attribute may have multiple correct attribute values. At step 406, the attribute value with the greatest frequency among all the attribute values of the attribute is identified.

In some embodiments, if the attribute value has only a single choice (e.g., where there is only one correct attribute value for a certain attribute) and the attribute is a required attribute, then the attribute is required to be input by all sellers. To avoid the problem of a wrong input by sellers, the attribute value with the greatest frequency among all the received and stored attribute values is determined as the correct attribute value of the attribute. For example, color is a required attribute of a mobile phone with type N009 and the attribute value of color is of a single choice. Red has been inputted as the attribute value of the attribute by 75% of sellers, black has been inputted as the attribute value of the attribute by 10% of the sellers, and gold has been inputted as the attribute value of the attribute by the other 15% of the sellers. The attribute value with the greatest frequency (e.g., red with the 75% rate of input) is determined as the attribute value of the color attribute of the N009 mobile phone.

At step 407, it is determined that the received attribute and its attribute value with the greatest frequency are SPU attribute information for the product.

In various embodiments, the SPU attribute information is stored for the product and displayed at the webpage at the trading platform for the product. Users (i.e., potential buyers) of the trading platforms may also search for the product based on its SPU attribute information.

At step 408, it is determined whether the frequency of the received attribute value is greater than an average frequency. If it is greater than the average frequency, then step 407 is performed, otherwise step 409 is performed.

In some embodiments, if the received attribute value is determined (e.g., in step 405) to correspond to an attribute of multiple correct attribute values, then the average of the frequencies of all the received attribute values of the attribute is calculated. The attribute value(s) with a frequency greater than the average frequency is determined as the attribute value(s) of the corresponding attribute in the SPU attribute information. For example, the color attribute of the mobile phone of type N001 has multiple correct choices of attribute values; 50% of sellers have inputted the value of the color attribute as black, 40% of sellers have inputted attribute value of the color attribute as red, and 10% of sellers have inputted attribute value of the color attribute as blue. Then the average frequency is (50%+40%+10%)/3=33.33%. The frequency of each received attribute value is compared with the average frequency. If the frequency is greater than the average frequency, then step 407 is performed, otherwise step 409 is performed.

At step 409, the difference between the greatest frequency and the average frequency is determined, and the difference is divided by the frequency of the received attribute value. Then the result is compared with a predetermined value. If it is less than the predetermined value, step 407 is performed, otherwise step 404 is performed.

In some embodiments, the predetermined value is 1.3. Returning to the color attribute information of the mobile phone of type N001. For example, the difference between the greatest frequency and the average frequency is 50%−33.33%=16.67%. Dividing the difference by 10% (the frequency of the received attribute value) and the result of 1.667. Since 1.667 is greater than 1.3, step 404 is performed. The predetermined value of 1.3 is used for purposes of illustration and other values may be used.

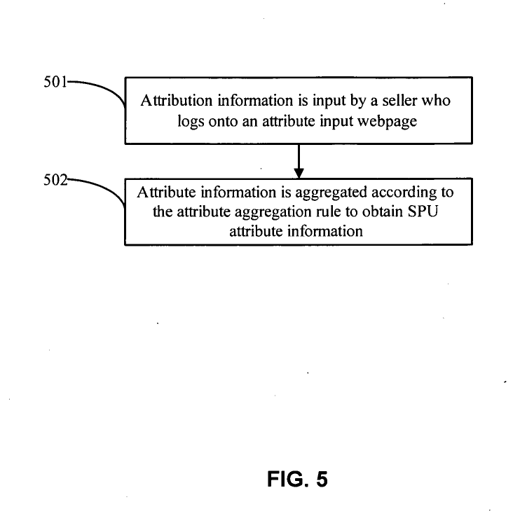

FIG. 5 is an example of attribute aggregation for creating SPU attribute information. In some embodiments, process 500 may be performed using process 400. Prior to creating SPU attribute information for products, generally, there is no stored standardized attribute information. Different sellers can input different attribute information for the same product. Manually revising the incorrect attribute information is very inefficient. However, attribute information may be aggregating according to process 400 to generate SPUs (e.g., to serve as reference information) to better ensure the display and association of correct attribute information to products.

A step 501, attribution information is input by a seller who logs onto an attribute input webpage.

At step 502, attribute information is aggregated according to the attribute aggregation rule to generate SPU attribute information.

For example, the product of the Nokia 7200 mobile phone has an attribute of ring tone and possible attribute values of 16-chord and 32-chord. Suppose that after statistical calculation, it is determined that more than 80% of the sellers have input attribute value of 16-chord, 10% of the sellers have input attribute value of 32-chord, and 10% of the sellers have not input any attribute value for the ring tone attribute. If there is only a single choice of the correct attribute value, then the attribute value of 16-chord is the included in the SPU set of attribute information because it has the greatest frequency of all the input attribute values. In that case, the attribute value of 32-chord is discarded (e.g., not stored).

An example of an attribute with multiple-choices of correct attribute values is the attribute of the type of memory card that is supported by a mobile phone. Suppose that the mobile phone supports memory card types of a SD card, MINISD card, MMC card, and so on. When sellers input the attribute value of this attribute, they can input only one kind, two kinds, or all the kinds of memory cards. The trading platform performs statistical calculations and aggregation (e.g., with the attribute information statistical functional module) according to the attribute information input by sellers and gets the following data:

The frequency that the attribute value of SD card is input (e.g., received by the aggregation server) is 50%, the frequency that the attribute value of MINISD card is input is 30%, the frequency that the attribute value of MMC card is input is 19%, and the frequency that other attribute values are input is 1%.

To identify the reference attribute value for this attribute of multiple-choice attribute values, first, the average frequency (25%) of the attribute value of the types of supported memory card is obtained. Since the frequency of the attribute value of MINISD card and the frequency of attribute value of SD card are greater than 25%, then according to the aggregation rule, both the attribute value of MINISD card and the attribute value of SD card are determined to be a part of the set of SPU attribute information for the product of the Nokia 7200 mobile phone.

Since the frequency of attribute value of MMC card is 19%, which is less than 25%, then according to the aggregation rule, further calculations are required: the difference between the greatest frequency and the average frequency is obtained, then the difference is divided by the frequency of the attribute value of MMC card (i.e., (50%−25%)/19%), and the result of this formula (1.31) is obtained. This value is compared with the predetermined value of 1.3, for example. Since 1.31>1.3, the attribute value of MMC card is discarded and it is not determined to be a part of the set of SPU attribute information for the product of Nokia 7200 mobile phone.

In this example, the above-mentioned two kinds of attribute information are all required attribute information (i.e., attribute information that is required to be displayed at the sale webpage of the product). For the non-required attribute information, the frequency of the attribute for the product is kept track of according to the attribute aggregation rule. The frequency is compared with a predetermined value. For example, the predetermined value is 60%. If greater than 60% of sellers have input this attribute information (e.g., if the attribute is input at least 60% of the time), then this attribute information is determined to be part of the set of SPU attribute information. Otherwise, the attribute information is discarded.

The time at which the aggregation of attribute information is executed may vary. In some embodiments, the time for aggregation of attribute information can be set to be immediately after the seller has completed the inputting of product attribute information. For example, as soon as the seller has inputted all of the product attribute information and has submitted the information, the trading platform may detect the submission of the product attribute information and immediately initiate or execute the SPU attribute aggregation process. In some embodiments, the trading platform can also execute SPU attribute aggregation of the attribute information on a periodic basis and where the period is predetermined.

In some embodiments, there are two kinds of methods by which a trading platform executes SPU attribute aggregation of product attribute information that is input by sellers:

In the first method, SPU attribute aggregation is executed for all the stored attribute information of a product every time SPU attribute aggregation takes place. That is to say, every time SPU attribute aggregation is executed, all attribute information including the attribute information that has already been accounted for in a previous SPU attribute aggregation is statistically calculated to obtain updated SPU attribute information.

In the second method, SPU attribute aggregation is executed according to the results of the last SPU attribute aggregation and to the newly stored attribute information since the last SPU attribute aggregation. That is to say, the results of each SPU attribute aggregation are recorded, and at the next SPU attribute aggregation, the process is executed according to the results of the most recent SPU attribute aggregation and the newly stored attribute information since the most recent SPU attribute aggregation. More about the second method is as follows:

The trading platform compiles statistics for every product attribute information since the last (i.e., most recent) SPU attribute aggregation. The trading platform records one or more of the following: the frequencies that each attribute and attribute value are input for a product, the number of users who search with respect to each attribute and/or attribute value, the total number of sellers who input attribute information in the current phase of SPU attribute aggregation, and the time of the last SPU attribute aggregation process. At the next SPU attribute aggregation, the trading platform obtains the attribute information stored since the last SPU attribute aggregation, and determines the number of sellers who has inputted attribute information of the product and the total number of sellers who sell the product, and executes SPU attribute aggregation according to the obtained/determined information.

Returning to the example with the product of the Nokia 7200 mobile phone, suppose that after some sellers have already input attribute information for the product, the trading platform executes SPU attribute aggregation for the first time. The statistical result of the SPU aggregation process is shown as follows:

Suppose there are 10 sellers, and 80% of the sellers have input the attribute value of 16-chord for the ring tone attribute, 10% of the sellers have input the attribute value of 32-chord for the ring tone attribute, and 10% of the sellers have not input any attribute value for the ring tone attribute. If the ring tone attribute has only a single choice correct attribute value, then the 16-chord attribute value is determined to be part of the set of SPU attribute information because it has the greatest frequency and the 32-chord attribute value input information is discarded.

Then, the trading platform records the number of sellers who inputs each attribute value and the total number of sellers of this product, as shown in TABLE.1:

TABLE 1

| Product | Number of sellers who input | Total number |
|---|---|---|
| attribute value | the attribute value (frequency) | of sellers |
| 16 chord | 8 (80%) | 10 |
| 32 chord | 1 (10%) | 10 |

In TABLE.1, the number of sellers who inputs each attribute information can also be expressed as a percentage of the total number of sellers, which may also be referred to as a frequency.

In the next SPU attribute aggregation, suppose there are 10 new sellers of the Nokia 7200 mobile phone product, and 50% of the 10 sellers have input the 16-chord attribute value for the ring tone attribute of the product, 40% have input the 32-chord attribute value. Then the frequencies of the attribute values are as follows:

The frequency of the 16-chord attribute value of the ring tone attribute becomes: (8+5)/20=65%,

The frequency of the 32-chord attribute value of the ring tone attribute becomes: (1+4)/20=25%.

In the case that the attribute value of the ring tone attribute is only a single choice, and because the attribute value of the 16-chord has the higher frequency, it is determined to be a part of the SPU attribute information of the Nokia 7200 mobile phone product.

By using the above disclosed method of receiving and storing attribute information inputted by user, aggregating the attribute information according to a predetermined rule(s) of attribute aggregation, SPU attributes may be automatically obtained, revised, and/or updated.

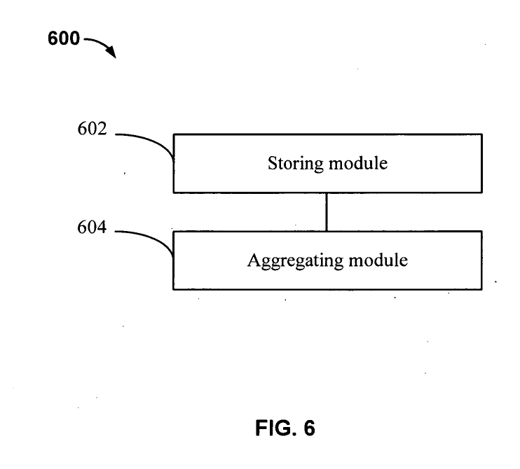

FIG. 6 is a diagram showing an embodiment of a system for attribute aggregation for generating SPU. In the example shown, system 600 includes storing module 602 and aggregating module 604.

The modules can be implemented as software components executing on one or more processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipments, etc.) implement the methods described in the embodiments of the present invention. The modules may be implemented on a single device or distributed across multiple devices

Storing module 602 is configured to store attribute information (e.g., attribute and attribute value) of a product.

In some embodiments, a trading platform may provide a user interface for sellers to input various attribute information of the products they are selling. Attribute information include information regarding both required attributes and non-required attributes (if there are any). In some embodiments, all of the input attribute information is stored in the trading platform (e.g., at the aggregation server supporting the trading platform) so that it is convenient to do various calculations with respect to the attribute information. The storage of attribute information can be set up in various ways. For example, the storage of attribute information may be grouped by each seller who inputs the attribute information or the storage of attribute information may be grouped by each SPU.

Aggregating module 604 is configured to aggregate attribute information stored by storing module 602 according to one or more predetermined attribute aggregation rules and generate SPU attribute information of the products. Further details regarding the aggregating module are described below.

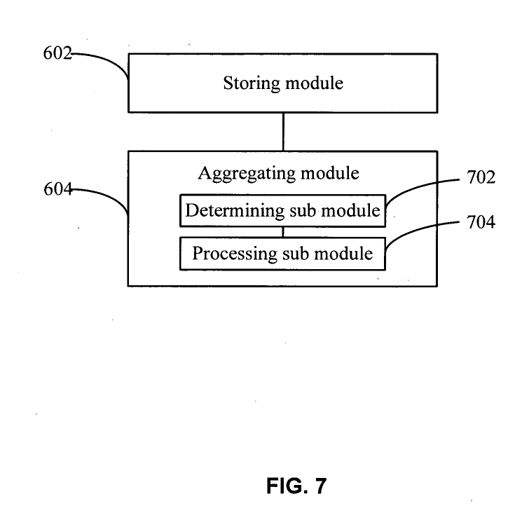

FIG. 7 is a diagram of an embodiment of a system for attribute aggregation for generating SPU. In some embodiments, system 600 may be implemented as the example shown in FIG. 7. In the example shown, determining sub module 702 and processing sub module 704 are sub components of aggregating module 604.

Determining sub module 702 is configured for determining whether the attribute of the input attribute information is a required attribute. In some embodiments, an attribute is determined to be a required attribute based on a predetermined list of attributes that are required to be displayed on the sale webpage of the product. If the attribute is not a required attribute, then it is deemed to be a non-required attribute.

Processing sub module 704 is configured for determining the frequency of the attribute in the stored attribute information of the product. When the attribute is deemed to be a non-required attribute: if the frequency of the attribute is less than a predetermined value, then it is determined that the attribute is not part of the set of SPU attribute information for the product. But if the frequency is greater than the predetermined value, then the attribute aggregation process is executed based in part on whether the attribute has a single or multi-choices of attribute values and the SPU attribute information for the product is subsequently generated. When the attribute is determined to be a required attribute, attribute aggregation is executed directly based on whether the attribute has a single or multi-choices of attribute values and the SPU attribute information of the product is subsequently generated.

Processing sub module 704 is also configured for:

When the attribute has a single choice attribute value, processing sub module 704 is configured to choose the attribute value of the attribute with the greatest frequency from all the stored attribute values of the attribute and include the attribute and attribute value with the greatest frequency in the set of SPU attribute information for the product.

When the attribute has multiple choices of attribute values, processing sub module 704 is configured to determine the frequencies of each stored attribute value of the attribute, calculate the average frequency of the frequencies of the multiple choices of attribute values, determine the attribute and the attribute value(s) with a frequency (or frequencies) greater than the average frequency and include the attribute and those attribute value(s) as part of the set of SPU attribute information for the product.

When the attribute has multiple choices of attribute values, processing sub module 704 is configured to determine the difference between the average frequency and the greatest frequency among the frequencies of the attribute values, then divide the difference, obtain a frequency ratio of the received attribute value, compare the frequency ratio with a predetermined ratio. If the frequency ratio is greater than the predetermined ratio, determine that the attribute value corresponding to the frequency ratio is not part of the set of SPU attribute information for the product, but if the frequency ratio is less than the predetermined ratio, determine that the attribute value corresponding to the frequency ratio is part of the set of SPU attribute information for the product.

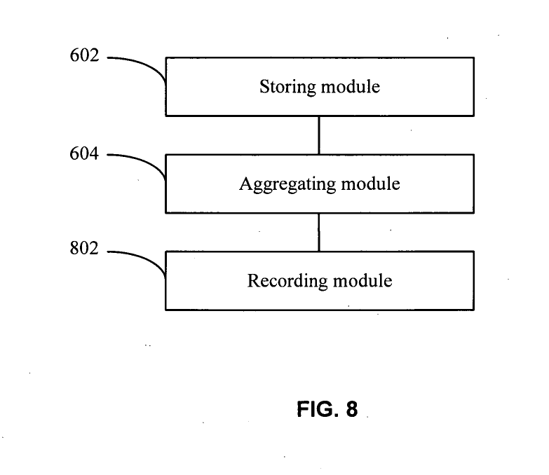

FIG. 8 is a diagram of an embodiment of a system for attribute aggregation for generating SPU. In some embodiments, the example shown in FIG. 8 is system 600 with the addition of recording module 802.

Recording module 802 is configured to, after the aggregating module obtains the SPU attribute information of a product, record one or more of the following: the frequency of each attribute and attribute value; the number of sellers who input each attribute and attribute value of the product, the total number of users who input any attribute information of the product in the current phase of attribute aggregation for the SPU for the product.

In some embodiments, aggregating module 604 is also configured to execute attribute aggregation for SPUs according to one or more of the following: the recorded frequency of each attribute and attribute value, the recorded number of users who input each attribute and attribute value of the product, and/or the recorded total number of users who input any attribute information of the product since the last attribute aggregation, and the newly stored attribute and attribute value of the product since the last attribute aggregation.

Through the description above, the technical personnel in this field can understand clearly that the present invention can be implemented by hardware or software. Based on this understanding, the technical program of the present invention can be embodied by a form of software products which can be stored in a nonvolatile storage medium (such as CD-ROM, flash disk, mobile hard disk, etc.), including in a number of instructions for permitting a device (such as a personal computer, server, or network equipment, etc.) to implement the methods described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of generating standardized attribute information comprising:
receiving an attribute and a corresponding attribute value for a product;
storing the attribute and the corresponding attribute value for the product,
determining a frequency of the attribute and a frequency of the corresponding attribute value;
aggregating the attribute and the corresponding attribute value based at least in part on the frequency of the attribute and the frequency of the corresponding attribute value according to a predetermined attribute aggregation rule, and
generating a standard product unit of attribute information for the product.

2. The method of claim 1, further comprising:
determining that the attribute is not required; and
comparing the frequency of the attribute with a predetermined value.

3. The method of claim 2, further comprising determining whether the attribute has a single is choice or multiple choices of attribute values.

4. The method of claim 3, in the event that it is determined that the attribute has a single choice of attribute values further comprising:
identifying a stored attribute value associated with the attribute with a greatest frequency as part of the standard product unit of attribute information for the product.

5. The method of claim 3, in the event that it is determined that the attribute has multiple choices of attribute values, further comprising:
identifying a plurality of stored attribute values associated with the attribute and a corresponding plurality of frequencies;
calculating an average frequencies based at least in part on the corresponding plurality of frequencies;
comparing each of the corresponding plurality of frequencies to the average frequency; and
identifying at least one of the plurality of stored attribute values associated with the attribute with the corresponding at least one plurality of frequencies greater than the average frequency as part of the standard product unit for the product.

6. The method according to claim 5, further comprising:
identifying one of the plurality of stored attribute values associated with the attribute with the corresponding one of the plurality of frequencies less than the average frequency;
determining a difference between the highest of the corresponding plurality of frequencies and the average frequency;
obtaining a ratio comprising of the difference divided by the identified corresponding one of the plurality of frequencies; and
comparing the ratio with a predetermined ratio.

7. The method of claim 6 wherein comparing the ratio with the predetermined ratio further comprises, if the ratio is less than the predetermined ratio, then identifying the identified one of the plurality of stored attribute values as part of the standard product unit for the product.

8. The method of claim 1, further comprising storing a frequency of each attribute and a frequency for each corresponding attribute value.

9. The method of claim 1, further comprising storing a number of users who input each attribute and attribute value for the product.

10. The method of claim 1, further comprising storing a total number of users who input attribute information for the product in a current attribute aggregation for the standard product unit.

11. The method of claim 1, wherein generating the standard product unit of attribute information includes identifying at least one attribute and at least one corresponding attribute value as reference information for the product.

12. A system of generating standardized attribute information, comprising:
one or more processors configured to:
receive an attribute and a corresponding attribute value for a product,
store the attribute and the corresponding attribute value for the product,
determine a frequency of the attribute and a frequency of the corresponding attribute value;
aggregate the attribute and the corresponding attribute value based at least in part on the frequency of the attribute and the frequency of the corresponding attribute value according to a predetermined attribute aggregation rule, and
generate a standard product unit of attribute information for the product; and
a memory coupled to the processor and configured to provide the processor with instructions.

13. The system of claim 12, further comprising:
determine that the attribute is not required; and
to compare the frequency of the attribute with a predetermined value.

14. The system of claim 13, further comprising determine whether the attribute has a single choice or multiple choices of attribute values.

15. The system of claim 14, in the event that it is determined that the attribute has a single choice of attribute values further comprising:
identify a stored attribute value associated with the attribute with a greatest frequency as part of the standard product unit of attribute information for the product.

16. The system of claim 14, in the event that it is determined that the attribute has multiple choices of attribute values, further comprising:
identify a plurality of stored attribute values associated with the attribute and a corresponding plurality of frequencies;
calculate an average frequencies based at least in part on the corresponding plurality of frequencies;
compare each of the corresponding plurality of frequencies to the average frequency; and
identify at least one of the plurality of stored attribute values associated with the attribute with the at least one corresponding plurality of frequencies greater than the average frequency as part of the standard product unit for the product.

17. The system according to claim 16, further comprising:
identify one of the plurality of stored attribute values associated with the attribute with the corresponding one of the plurality of frequencies less than the average frequency;
determine a difference between the highest of the corresponding plurality of frequencies and the average frequency;
obtain ratio comprising of the difference divided by the identified corresponding one of the plurality of frequencies; and
compare the ratio with a predetermined ratio.

18. The system of claim 12, wherein generate the standard product unit of attribute information includes identify at least one attribute and at least one corresponding attribute value as reference information for the product.

19. A computer program product for generating standardized attribute information, the to computer program product being embodied in a computer readable storage medium and comprising computer instructions for:
receiving an attribute and a corresponding attribute value for a product,
storing the attribute and the corresponding attribute value for the product,
determining a frequency of the attribute and a frequency of the corresponding attribute value;
aggregating the attribute and the corresponding attribute value based at least in part on the frequency of the attribute and the frequency of the corresponding attribute value according to a predetermined attribute aggregation rule, and
generating a standard product unit of attribute information for the product.
